(19) United States
(12) Patent Application Publication
(10) Pub. No.: US 2021/0142104 A1
(43) Pub. Date: May 13, 2021

(54) VISUAL ARTIFICIAL INTELLIGENCE IN SCADA SYSTEMS

(71) Applicant: AVEVA SOFTWARE, LLC, Lake Forest, CA (US)

(72) Inventors: Brian Kenneth Erickson, Long Beach, CA (US); Klaus Graefensteiner, Mission Viejo, CA (US); Ken May, Lake Forest, CA (US); Vinay T. Kamath, Rancho Santa Margarita, CA (US)

(21) Appl. No.: 17/095,251

(22) Filed: Nov. 11, 2020

Related U.S. Application Data
(60) Provisional application No. 62/933,722, filed on Nov. 11, 2019.

(51) Int. Cl. G06K 9/62; G06N 20/00; G06F 11/32

(52) U.S. Cl. CPC G06K 9/6253; G06F 11/327; G06N 20/00; G06K 9/6267

(57) ABSTRACT

Disclosed are systems and methods for improving interactions with and between computers in content providing, displaying and/or hosting systems supported by or configured with devices, servers and/or platforms. The disclosed systems and methods provide a novel artificial intelligence (AI) framework that integrates image capture and classification functionality within SCADA systems. The disclosed AI framework involves operation of a set of network-connected cameras within SCADA systems for provided visual surveillance to periodically or substantially continuously view, detect or identify current conditions, or conditions that satisfy a criteria. The disclosed systems and methods, therefore, provide an automated mechanism for monitoring conditions within SCADA systems, and alerting end users or applications to take an action using AI.

### CROSS-REFERENCE TO RELATED APPLICATIONS

This application claims the benefit of priority from U.S. Provisional Application No. 62/933,722, filed Nov. 11, 2019, entitled “Visual Artificial Intelligence in SCADA Systems,” which is incorporated herein by reference in its entirety.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

Some embodiments relate generally to improving the performance of network-based computerized content displaying, hosting and providing devices, systems and/or platforms by modifying the capabilities and providing non-native functionality to such devices, systems and/or platforms through a novel and improved framework for executing visual artificial intelligence (AI) in order to capture, analyze, classify and present digital image content within a Supervisory Control and Data Acquisition (SCADA) system.

### BACKGROUND

SCADA systems refer to a distributed computing system that collects and analyzes information. SCADA systems are typically employed in a wide variety of industrial sites and facilities such as, without limitation, a chemical plant, food and beverage plant, infrastructure facility, laboratory, marine facility, mining site, oil/gas facility, power/utility facility, pulp and paper factory, manufacturing facility, metal fabrication site, water/waste facility and the like. A SCADA system can monitor for various conditions relating to the health and operation of an industrial site, and can also control aspects of the site or facility, or assets operating therein.

### SUMMARY

The disclosed systems and methods provides advanced mechanisms for integrating image capture and classification within SCADA systems through a novel framework based on artificial intelligence (AI). According to some embodiments, the disclosed AI framework involves operation of a set of network-connected cameras for integration into SCADA systems.

In some embodiments, network-connected cameras provide visual surveillance in SCADA systems can require an operator to periodically or substantially continuously view, detect or identify current conditions, or conditions that satisfy a criteria.

As in conventional systems, a lack of supervision due to insufficient monitoring can be catastrophic in these systems. Some embodiments, therefore, provide an automated mechanism for monitoring conditions and alerting end users to take an action using artificial intelligence (AI). Some embodiments also provide a workflow for connecting, configuring and training an AI system to prepare for monitoring. Some embodiments enable the use of relatively inexpensive, passive cameras coupled to sophisticated data processing and analytics capabilities.

Some embodiments provide methods and systems for asset management and visualization. Some embodiments of the present disclosure involve composing selected data based on asset metrics and rendering a display that conveys a unified, asset-centric analytics user interface. As a non-limiting example, some industrial sites employ hundreds or thousands of assets to carry out industrial operations. Ensuring the correct operation of assets is critical to managing an industrial site.

Assets, which can be both physical as well as digital (e.g., computer programs executing on a physical asset) can experience several issues such as unscheduled downtime, failure, defects, maintenance, unproductivity, and other issues that affect the efficiency and workflow of the industrial site.

Thus, some embodiments provide novel computerized mechanisms for configuring, training, and connecting to SCADA systems. Some embodiments of the present disclosure enable a more efficient, less network- and/or computerized-resource dependent manner to integrate monitoring of the visual data from SCADA systems by using the process variables to trigger image capture and report classification status.

Some embodiments involve capturing of images based on SCADA control variables. In some embodiments, a methodology, algorithm or set of criteria for label classification can be provided for captured images within an application tool. In some embodiments, auto-training classified images can include feedback loops. Thus, upon classification of an image or image set, the classification information (or information related to how the image/image set is classified) can be fed back (e.g., a recursive loop) to the auto-training process for subsequent classifications.

Some embodiments comprise an automated transfer learning model. Some embodiments comprise a simplified method for configuring thresholds for false positives vs. false negatives. Some embodiments comprise a slider or other control for adjusting parameters of interest.

Some embodiments comprise set SCADA variables based on image classification during monitoring. Some embodiments comprise dynamically determined and applied SCADA variables based on image classification during monitoring. Some embodiments comprise a workflow within the SCADA system. Some embodiments comprise distributed asset systems. Some embodiments comprise workflow within the SCADA system. In some embodiments, operators are permitted perform visual AI operations efficiently without the need to know about AI algorithms or methodologies.

According to some embodiments, a computer-implemented method is disclosed for capturing, analyzing and classifying digital image content via an AI framework within SCADA systems.

Some embodiments provide a non-transitory computer-readable storage medium for carrying out the above mentioned technical steps of the framework's functionality. The non-transitory computer-readable storage medium has tangibly stored thereon, or tangibly encoded thereon, computer readable instructions that when executed by a device (e.g., application server, messaging server, email server, ad server, content server and/or client device, and the like) cause at least one processor to perform a method for capturing, analyzing and classifying digital image content via an AI framework within SCADA systems.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

According to some embodiments, a computing device is disclosed which comprises: one or more processors; and a non-transitory computer-readable memory having stored therein computer-executable instructions, that when executed by the one or more processors, cause the one or more processors to perform actions comprising: identifying an image dataset, the image dataset comprising a set of images depicting types of content associated with a set of physical assets at a location; defining a binary classifier, executing in association with the computing device, based on a set of categories for classifying the image dataset; applying the binary classifier to the image dataset, and based on the application, determining a training model for application by a set of cameras at the location; monitoring the location via execution of the training model, the monitoring comprising capturing, by the set of cameras, a second set images, each image in the second set comprising captured content occurring at the location in association with at least one physical asset; analyzing the second set of images based on the training model; automatically classifying, based on the analysis, each of the images in the second set of images; and displaying, within a user interface (UI), the second set of images and information indicating the classification based on the analysis and classification performed by the training model.

In some embodiments, the image dataset comprises a plurality of predetermined images.

In some embodiments, the action further comprise: capturing, via at least one of the set of cameras, a third set of images, where the identified image dataset comprises the captured third set of images.

In some embodiments, the action further comprise: analyzing the image dataset, and determining a type of the set of images; and identifying the set of categories based on the determined type. In some embodiments, the action further comprise: identifying a second set of categories, the second set of categories being based on another type of set of images; and converting settings associated with the second set of categories, the conversion causing a transfer modelling of the second set of categories to correspond to the type of the set of categories, where the second set of categories is used for defining the binary classifier.

In some embodiments, the action further comprise: updating the training model based on information associated with the information indicating the classification of the second set of images; and applying the updated training model to a fourth set of images.

In some embodiments, the UI further comprises a display, including: a portion for viewing a classification of a captured image within the second set of images; a portion for capturing another set of images for classification; and a portion for selecting images from the other set of images for classification.

In some embodiments, the monitoring is performed when the computing device is in runtime mode.

In some embodiments, the monitoring is automatically performed based on execution of the training model.

In some embodiments, the actions are performed via an image training application executing in association with the computing device

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 illustrates a high-level flow of an image training application according to some embodiments of the present disclosure;

FIG. 2 illustrates an image training application layout according to some embodiments of the present disclosure;

FIG. 3 illustrates an artificial intelligence profile dropdown menu according to some embodiments of the present disclosure;

FIG. 4 illustrates a new model configuration according to some embodiments of the present disclosure;

FIGS. 5A-5B illustrate training views according to some embodiments of the present disclosure;

FIG. 6 illustrates a networked environment enabling the visual artificial intelligence system according to some embodiments of the present disclosure;

FIG. 7 illustrates a flowchart depicting the operation of an image training application executed in the networked environment of FIG. 6 according to some embodiments of the present disclosure; and

FIG. 8 illustrates a schematic diagram of a computing system implemented in the networked environment of FIG. 6 according to some embodiments of the present disclosure.

### DESCRIPTION OF EMBODIMENTS

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, cloud storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure, a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router (WR) mesh, or 2nd, 3rd, 4^{th} or 5^{th} generation (2G, 3G, 4G or 5G) cellular technology, Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments will now be described in greater detail with reference to the figures. FIG. 1 illustrates a high-level, non-limiting flow diagram of an image training application according to some embodiments of the present disclosure. According to some embodiments, the image training application disclosed herein allows a user to build a dataset of images (related to, but not limited to, assets, locations, operations, products, and the like) and train a deep learning model to automatically classify images into various classes or categories.

In some embodiments, the image dataset can comprise any type of image content—for example, set of images depicting types of content associated with a set of physical assets at a location(s).

According to some embodiments, the high-level flow of the image training application can be divided into three levels. The top level prepares the data to be fed into a training model (Steps 150-154). Here, according to some embodiments, a user can select an image dataset that previously exists. Step 150. In some embodiments, the user can spontaneously change the image dataset by adding to, removing or identifying an different dataset.

In some embodiments, the user can use a camera to take photos for storage as useful images. Step 152. In this case, the user can select a camera connected to a network. In some embodiments, the user can provide login credentials to authenticate the user. Images can be captured according to a set of user-specified rules. For example, the images can be captured on a schedule (e.g., once an hour). The user can also specify a directory to store captured images, thereby creating an image dataset.

Once the image dataset is selected or otherwise created through automatic or other capture, the images can be automatically classified into a category. Step 154. In some embodiments, a user identifies the categories or the number of categories. The user can set a maximum number of categories. In some embodiments, users are permitted to manually classify images into separate categories after a predetermined number of images is present in the dataset.

In some embodiments, the middle level trains the acquired data (Steps 156-158). For example, a user selects and configures a deep learning model to train and start the training. Step 156. According to some embodiments, the deep learning model can be implemented using any known or to be known deep learning, machine learning or AI algorithm, technique, technology or mechanism, including, but not limited to, computer vision, neural networks, and the like. In some embodiments, the result is the generation of training data based on the inputted image dataset. Step 158. Thus, a training model can be created based on the image dataset.

In some embodiments, at the bottom level (Step 160), the training model is created to predict new images. In some embodiments, once the training ends, the user can capture additional images using a selected camera. The training model can classify the newly acquired images into specified categories. In some embodiments, the training model can trigger the capture of images, such that the capture and classification occurs automatically based on analyzed image frames via the trained model. In some embodiments, classified images can be seen through use of a menu, a slider or other interface.

FIG. 2 illustrates a non-limiting example of an image training application layout according to some embodiments of the present disclosure. In some embodiments, the image training application presents an intuitive user interface (UI) for creating an image dataset, generating a training model based on the image dataset, and then classifying addition images.

According to some embodiments, a user begins by launching the image training application. In some embodiments, the image training application can be launched from a separate application. In some embodiments, the image training application can be a stand-alone application. In some embodiments the image training application can be configured as an augmenting script, extension or plug-in to a third party image capture application.

In some embodiments, a user can select “Start Capture” in the camera feedback view. In response, the camera takes pictures and the resulting images are stored as an image dataset and displayed in a dataset view. The dataset view presents several thumbnails of images in the dataset.

The dataset view initially presents images in the dataset under an “Unclassified” tab. In some embodiments, the training checkbox can be checked or unchecked. The UI of FIG. 2 in the image training application allows the user to toggle between “training mode” and “test mode.” Training mode presents the images in a thumbnail or grid form that are part of the dataset used to create the training model. Test mode presents images that are used to test the training model after it has been created.

The UI in the image training application enables a user to click on individual images to select them—e.g., within the “dataset view” portion of the UI. A user can click the “control” key to select multiple images. Upon selecting one or more images, the user can classify them according to a category by clicking on the desire category. This allows a user to tag or otherwise label multiple images for creating the training model. In addition, as shown in FIG. 2, the user can click on an image to present an enlarged version of the image for inspection—e.g., within the “zoomed view” of the UI.

FIG. 3 illustrates a non-limiting example of an AI profile dropdown menu according to some embodiments of the present disclosure. In some embodiments, a user can label each image. In some embodiments, once the labelling of each label or multiple labels is complete, the user can select a deep learning model from a plurality of deep learning models to be applied to the labeled image dataset. In some embodiments, a user can click on the dropdown menu of “AI Profile” to select an existing profile.

FIG. 4 illustrates a non-limiting example embodiment of a new model configuration according to some embodiments of the present disclosure. According to some embodiments, FIG. 4 depicts how a training model can be created by leveraging a preexisting training model based on a different dataset and applying it to a new dataset. For example, if a training model created for classifying metal drums was created, a user can transfer that training model to create a new training model for classifying plastic receptacles. This is referred to as “transfer learning.” Transfer learning can reduce the amount of time it takes to generate a training model by using a similar training model based on a different dataset.

To transfer a training model, a user can click on the “New” button to create a new profile. A user can select the “Transfer Model” and save by clicking the “Save” button. In some embodiments, a user can configure any model by clicking on the “Config” button.

In some embodiments, when configuring the transfer or conversion of a training model, the user can use default settings. In some embodiments, new or modified, or customized settings can be configured, that, in some embodiments, are specific to a type of asset or item that is the destination of the transfer.

In some embodiments, the user can decide how many epochs they want to for training the new model. The user can specify the names of the categories to be classified. The user can specify category thresholds or the tolerance rate for false positives and false negatives. The higher the threshold the less tolerance it can have. For example, if the user selects a threshold of 0.9 using a slider, the model can only add the image in the category if it has a 90% confidence for belonging in a particular category.

In some embodiments, the images that do not belong to any category can be sent to the “Unclassified” folder. In some embodiments, a user can slide the images separately by unchecking “Lock Thresholds”. The user can save the configuration after the user specifies the parameters.

FIGS. 5A-5B illustrate training views according to some embodiments of the present disclosure. According to some embodiments, a user can read the “Status” in the training view while in training mode. The user can select “Start Training”. A user can see a graphical representation dynamically appear in the training view as the training model is being constructed. In some embodiments, a “Status” can be displayed as “training in progress”. The training can end after given a number of epochs or if the model converges (whichever comes first). In some embodiments, a user can stop the training by selecting the “Stop Training After Epoch” option.

According to some embodiments, training the image dataset can generate, for example, an .h5 file in every epoch but will only keep the weights file with the highest accuracy at the end of training. Once the training ends, a user can start the camera again to take pictures for generating a new image dataset for testing the training model. A can select “Start” in the training view to start classifying. In some embodiments, a user can uncheck the “Training” box to view the classified images. In this respect, the user toggles out of training mode into a test mode. The user can open the tabs of the categories to see which images have been classified to that category in test mode.

In some embodiments, a user can view the enlarged versions of images in the zoomed view. The user interface renders pre-assigned colors to surround an image for indicating a corresponding category or classification. According to some embodiments, a user can retrain the same model for better accuracy but with different images, otherwise it will overfit.

FIG. 6 shows a networked environment 100 according to various embodiments. The networked environment 100 includes a computing system 101 that is made up of a combination of hardware and software. The computing system 101 includes a data store 103 and an image training application 106. The computing system 101 can be connected to a network 108 such as the Internet, intranets, extranets, wide area networks (WANs), local area networks (LANs), wired networks, wireless networks, or other suitable networks, etc., or any combination of two or more such networks.

The computing system 101 can comprise, for example, a server computer or any other system providing computing capability. Alternatively, the computing system 101 can employ a plurality of computing devices that can be arranged, for example, in one or more server banks or computer banks or other arrangements. Such computing devices can be located in a single installation or can be distributed among many different geographical locations. For example, the computing system 101 can include a plurality of computing devices that together can comprise a hosted computing resource, a grid computing resource and/or any other distributed computing arrangement. In some cases, the computing system 101 can correspond to an elastic computing resource where the allotted capacity of processing, network, storage, or other computing-related resources can vary over time. The computing system 101 can implement one or more virtual machines that use the resources of the computing system 101.

Applications and/or other functionality can be executed in the computing system 101 according to various embodiments. Also, various data is stored in the data store 103 or other memory that is accessible to the computing system 101. The data store 103 can be implemented as a database or storage device.

As mentioned above, the components executed on the computing system 101 include the image training application 106, which can access, modify, and/or generate the contents of the data store 103. The image training application 106 generates a user interface that allows users to select data sets, capture images, view image datasets tag images, generate new training models transfer training models for reconfiguration, and execute classifications. The image training application 106 can be implemented as a server-side application that generates web-based documents. Such documents can be hypertext markup language (HTML) documents dynamic HTML documents, extended markup language (XML) documents, or other documents or data that can be decoded and rendered to present data to a user. The image training application 1096 may include software that sends and receive data packets or other information being communicated over a network 108.

In some embodiments, information stored in the data store 103 includes user accounts 118, training datasets 118, test datasets 121 and training models. User accounts 118 can include information to provide a customized user interface as well as a user's login credentials to access the image training application 106. The training dataset 118 comprises a collection of images used to create a training model 124. The training dataset 118 can initially be unlabeled. A user can manually tag or label the training dataset 121. The test dataset 121 comprises a collection of images that are initially unlabeled. The test dataset 121 can be classified by a classifier that uses a training model 124.

The networked environment 100 also includes an industrial site 130 in some non-limiting embodiments. An industrial site 130 can be a chemical plant, food and beverage plant, infrastructure facility, laboratory, marine facility, mining site, oil/gas facility, power/utility facility, pulp and paper factory, manufacturing facility, metal fabrication site, a water/waste facility, and the like. The industrial site 130 includes at least several assets in some embodiments. An asset is an item, structure, device, or system that provides a function or is otherwise important with respect to the industrial site 130. An asset can be, for example, a tool, a machine, a computing module, a structure, a vehicle, or an industrial component.

In some embodiments, the industrial site 130 includes one or more cameras 144. A camera can be an optical sensor or other imaging device for capturing video or still pictures. Each camera is configured to communicate with computing system 101 over the network 108.

In some embodiments, the networked environment 100 also includes one or more client device(s) 124. A client device 152 allows a user to interact with the components of the computing system 101 over a network 108. A client device 152 can be, for example, a cell phone, laptop, personal computer, mobile device, or any other computing device used by a user. The client device 152 can include an application such as a web browser or mobile application that communicates with the image training application 106 to build training models 124 and execute classification of assets in industrial site 102 using the training models. The client device 152 can render the user interface using, for example, a browser or dedicated application.

FIG. 7 is a flowchart illustrating an example of the functionality of the image training application 106 implemented in a networked environment 100 of FIG. 6 according to some embodiments. It is understood that the flowchart of FIG. 7 provides merely an example of the many different types of functional arrangements that can be employed to implement the image training application 106 as described herein. The flowchart of FIG. 7 can be viewed as depicting an example of elements of a method implemented by the image training application 106 according to some embodiments.

In some embodiments, at item 701, the image training application 106 determines whether it is in training mode. Training mode is a mode that creates training models 124 based on training datasets 118. In some embodiments, when not in training mode, the image training application 106 can be in test mode which is used to test training models. In some embodiments, the image training application 106 can be in run-time mode in order to perform classification in a run time environment. If the image training application 106 is in training mode, the flowchart proceeds to item 705.

In some embodiments, at item 705, the image training application 106 can create a training model 124 based on a new training data 118 or using a training model transfer that leverages a preexisting training model 124 and reconfigures it to apply to a new training dataset 118, as discussed above. If there is no transfer of a preexisting training model 124, the flowchart proceeds to item 710.

In some embodiments, at item 710, the image training application 106 presents the user with the option to select a preexisting training dataset or to create a new training dataset. In some embodiments, at item 715, the image training application 106 prompts the user to select the location of a training dataset 118. However, if the user wishes to create a new training dataset 118, then, at item 720, the image training application 106 prompts the user to perform an image capture to generate a training dataset 118. In this case, in some embodiments, the image training application 106 authenticates the user using credentials, then receives a selection for a camera 144.

In some embodiments, through a user interface rendered by the image training application 106, the user can identify one or more image capture rules such as the frequency for capturing an image using the selected camera 144, image capture criteria such as, for example, image quality, and a location to store captured images. After a sufficient number of images are captured, the training dataset 118 is complete. In some embodiments, a predetermined minimum number of images is needed for the training dataset 118 to be considered complete.

In some embodiments, once a training dataset 118 is identified (either by selecting a preexisting dataset or by generating a new dataset from image capture), then, at item 725, the image training application 106 presents a user interface for obtaining a plurality of labels. An example of the user interface is described above with respect to FIG. 2. The user interface provides multiple images in the training dataset 118 using a grid view. The user interface allows for the selection and/or interaction of multiple images to then be simultaneously labeled. In some embodiments, the UI can also provide a preview window to display a selected image.

In some embodiments, at item 730, the image training application 106 generates a training model 124. For example, using the manually labeled training dataset 118, a user can specify parameters to generate a training model 124. As the image training application 106 generates the training model 125, it can display the status as the training model is generated in real time. The process completes upon the training model being generated.

When generating a training model, a binary classifier can be used to classify images. In some embodiments, the user can specify the confidence level threshold using a sliding scale or other interface to designate how an image should be classified. The user can also name each classification. For example, assets in an industrial environment can need to be classified into categories, such as, but not limited to, “approved”, “rejected”, “defective”, “not defective”, and the like. A user can name the labels as part of the training model generation.

In some embodiments, at item 735, the user can intend to create a training model from a preexisting training model. Thus, at item 735 the image training application 106 identifies a preexisting training model. The preexisting training model can have been generated according to a first training dataset. The user may wish to reconfigure the training model to apply to a second training dataset. In some embodiments, the image training application 106 provides a menu to permit the user to select one among a plurality of preexisting training models.

In some embodiments, at item 740, the image training application 106 reconfigures the selected training model. This can be referred to as an automated transfer learning model. This is described above with respect to FIG. 4. The process completes upon the training model being generated.

When the user choses a test mode or runtime mode, as opposed to a training mode, then, at item 701, the image training application 106 selects a test dataset 121 to test. The image training application 106 can generate a user interface to allow a user to load a selected test dataset 121.

In some embodiments, at item 740, the image training application 106 executes a classifier using the training model. The classifier automatically labels the images in the test dataset 121. In some embodiments, the user can evaluate the accuracy of the training model 124 based on the classifier output. This allows a user to reconfigure the training model, adjust threshold confidence levels, or create new training datasets to fine tune the training model 124.

Thus, as discussed above, upon the capture of an additional image(s), the training (or trained) model can be applied and automatically, without user input, automatically analyze and classify the newly acquired image(s) into specified categories. In some embodiments, a classified image(s) can be visibly displayed within a user interface (UI) in accordance with a menu, slider or other interface object, and in some embodiments, the classified image can be displayed along with augmenting data indicating the classification that occurred. In some embodiments, information related to how a set of images are classification (e.g., type classification, which content was classified and in which manner, for example) can be fed back (e.g., via recursive functionality associated with the image training application) to training model for subsequent classifications within runtime (e.g., another set of images being captured) or training modes.

FIG. 8 is a schematic block diagram that provides one example illustration of a computing system 101 of FIG. 6 according to some embodiments. The computing system 101 can include one or more computing devices 800. Each computing device 800 can include at least one processor circuit, for example, having a processor 803 and memory 806, both of which are coupled to a local interface 809 or bus. Each computing device 800 can comprise at least one server computer or like device. The local interface 809 can comprise a data bus with an accompanying address/control bus or other bus structure.

Data and several components can be stored in memory 806. The data and several components can be accessed and/or executable by the processor 803. The image training application 106 can be stored in memory 806 and executable by processor 803. Data store 103 and other data can be stored in memory 806. An operating system can be stored in memory 806 and executable by processor 803.

Other applications can be stored in memory 806 and can be executable by processor 803. Any component discussed herein can be implemented in the form of software, any one of a number of programming languages can be employed, for example, C, C++, C#, Objective C, Java®, JavaScript®, Perl, PHP, Visual Basic®, Python®, Ruby, or other programming languages.

Several software components can be stored in memory 806 and can be executable by processor 803. The term “executable” can be described as a program file that is in a form that can ultimately be run by processor 9803. Examples of executable programs can be, a compiled program that can be translated into machine code in a format that can be loaded into a random access portion of memory 806 and run by processor 803, source code that can be expressed in proper format such as object code that is capable of being loaded into a random access portion of memory 806 and executed by processor 803, or source code that can be interpreted by another executable program to generate instructions in a random access portion of memory 806 to be executed by processor 803, and the like. An executable program can be stored in any portion or component of memory 806, for example, random access memory (RAM), read-only memory (ROM), hard drive, solid-state drive, USB flash drive, memory card, optical disc such as compact disc (CD) or digital versatile disc (DVD), floppy disk, magnetic tape, or any other memory components.

The memory 806 can be defined as including both volatile and nonvolatile memory and data storage components. Volatile components can be those that do not retain data values upon loss of power. Nonvolatile components can be those that retain data upon a loss of power. Memory 806 can comprise random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. Embodiments, RAM can comprise static random-access memory (SRAM), dynamic random access memory (DRAM), or magnetic random access memory (MRAM) and other such devices. Embodiments, ROM can comprise a programmable read-only memory (PROM), an erasable programmable read-only memory (EPROM), an electrically erasable programmable read-only memory (EEPROM), or other like memory device.

The processor 803 can represent multiple processors 803 and/or multiple processor cores and memory 806 can represent multiple memories 806 that can operate in parallel processing circuits, respectively. The local interface 809 can be an appropriate network that facilitates communication between any two of the multiple processors 803, between any processor 803 and any of the memories 806, or between any two of the memories 806, and the like. the local interface 809 can comprise additional systems designed to coordinate this communication, for example, performing load balancing. the processor 803 can be of electrical or other available construction.

The image training application 106 can be embodied in software or code executed by hardware as discussed above, as an alternative the same can also be embodied in dedicated hardware or a combination of software/hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, and the like. Technologies can generally be well known by those skilled in the art and, consequently, are not described in detail herein.

The operations described herein can be implemented as software stored in computer-readable medium. Computer-readable medium can comprise many physical media, for example, magnetic, optical, or semiconductor media. Examples of a suitable computer-readable medium can include, but are not limited to, magnetic tapes, magnetic floppy diskettes, magnetic hard drives, memory cards, solid-state drives, USB flash drives, or optical discs. Embodiments, computer-readable medium can be a random-access memory (RAM), for example, static random-access memory (SRAM) and dynamic random access memory (DRAM), or magnetic random access memory (MRAM). Computer-readable medium can be a read-only memory (ROM), a programmable read-only memory (PROM), an erasable programmable read-only memory (EPROM), an electrically erasable programmable read-only memory (EEPROM), or other type of memory device.

Any logic or application described herein, including the image training application 106 can be implemented and structured in a variety of ways. One or more applications described can be implemented as modules or components of a single application. One or more applications described herein can be executed in shared or separate computing devices or a combination thereof. For example, the software application described herein can execute in the same computing device 800, or in multiple computing devices in the same computing system 101. Additionally, it is understood that terms such as “application,” “service,” “system,” “engine,” “module,” and so on can be interchangeable and are not intended to be limiting.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternative embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A computing device comprising:
one or more processors;
a non-transitory computer-readable memory having stored therein computer-executable instructions, that when executed by the one or more processors, cause the one or more processors to perform actions comprising:
identifying an image dataset, the image dataset comprising a set of images depicting types of content associated with a set of physical assets at a location;
defining a binary classifier, executing in association with said computing device, based on a set of categories for classifying said image dataset;
applying said binary classifier to said image dataset, and based on said application, determining a training model for application by a set of cameras at said location;
monitoring said location via execution of the training model, said monitoring comprising capturing, by said set of cameras, a second set images, each image in said second set comprising captured content occurring at said location in association with at least one physical asset;
analyzing the second set of images based on the training model;
automatically classifying, based on said analysis, each of the images in said second set of images; and
displaying, within a user interface (UI), said second set of images and information indicating said classification based on the analysis and classification performed by the training model.

2. The computing device of claim 1, wherein said image dataset comprises a plurality of predetermined images.

3. The computing device of claim 1, further comprising:
capturing, via at least one of the set of cameras, a third set of images, wherein said identified image dataset comprises said captured third set of images.

4. The computing device of claim 1, further comprising:
analyzing the image dataset, and determining a type of the set of images; and
identifying the set of categories based on said determined type.

5. The computing device of claim 4, further comprising:
identifying a second set of categories, said second set of categories being based on another type of set of images; and
converting settings associated with said second set of categories, said conversion causing a transfer modelling of the second set of categories to correspond to the type of the set of categories, wherein said second set of categories is used for defining said binary classifier.

6. The computing device of claim 1, further comprising:
updating said training model based on information associated with the information indicating said classification of the second set of images; and
applying said updated training model to a fourth set of images.

7. The computing device of claim 1, wherein said UI further comprises a display, comprising:
a portion for viewing a classification of a captured image within said second set of images;
a portion for capturing another set of images for classification; and
a portion for selecting images from said other set of images for classification.

8. The computing device of claim 1, wherein said monitoring is performed when said computing device is in runtime mode.

9. The computing device of claim 1, wherein said monitoring is automatically performed based on execution of the training model.

10. The computing device of claim 1, wherein said actions are performed via an image training application executing in association with said computing device.

11. A method comprising:
identifying, by a computing device, an image dataset, the image dataset comprising a set of images depicting types of content associated with a set of physical assets at a location;
defining, by the computing device, a binary classifier, executing in association with said computing device, based on a set of categories for classifying said image dataset;
applying, by the computing device, said binary classifier to said image dataset, and based on said application, determining a training model for application by a set of cameras at said location;
monitoring, by the computing device, said location via execution of the training model, said monitoring comprising capturing, by said set of cameras, a second set images, each image in said second set comprising captured content occurring at said location in association with at least one physical asset;
analyzing, by the computing device, the second set of images based on the training model;
automatically classifying, by the computing device, based on said analysis, each of the images in said second set of images; and
displaying, by the computing device, within a user interface (UI), said second set of images and information indicating said classification based on the analysis and classification performed by the training model.

12. The method of claim 11, wherein said image dataset comprises a plurality of predetermined images.

13. The method of claim 11, further comprising:
capturing, via at least one of the set of cameras, a third set of images, wherein said identified image dataset comprises said captured third set of images.

14. The method of claim 11, further comprising:
analyzing the image dataset, and determining a type of the set of images;
identifying the set of categories based on said determined type;
identifying a second set of categories, said second set of categories being based on another type of set of images; and
converting settings associated with said second set of categories, said conversion causing a transfer modelling of the second set of categories to correspond to the type of the set of categories, wherein said second set of categories is used for defining said binary classifier.

15. The method of claim 11, further comprising:
updating said training model based on information associated with the information indicating said classification of the second set of images; and
applying said updated training model to a fourth set of images.

16. The method of claim 11, wherein said UI further comprises a display, comprising:
a portion for viewing a classification of a captured image within said second set of images;
a portion for capturing another set of images for classification; and
a portion for selecting images from said other set of images for classification.

17. The method of claim 11, wherein said monitoring is automatically performed based on execution of the training model.

18. The method of claim 11, wherein said actions are performed via an image training application executing in association with said computing device.

19. A non-transitory computer-readable storage medium tangibly encoded with computer-executable instructions, that when executed by a processor associated with a computing device, performs a method comprising:
identifying, by the computing device, an image dataset, the image dataset comprising a set of images depicting types of content associated with a set of physical assets at a location;
defining, by the computing device, a binary classifier, executing in association with said computing device, based on a set of categories for classifying said image dataset;
applying, by the computing device, said binary classifier to said image dataset, and based on said application, determining a training model for application by a set of cameras at said location;
monitoring, by the computing device, said location via execution of the training model, said monitoring comprising capturing, by said set of cameras, a second set images, each image in said second set comprising captured content occurring at said location in association with at least one physical asset;
analyzing, by the computing device, the second set of images based on the training model;
automatically classifying, by the computing device, based on said analysis, each of the images in said second set of images; and
displaying, by the computing device, within a user interface (UI), said second set of images and information indicating said classification based on the analysis and classification performed by the training model.

20. The non-transitory computer-readable storage medium of claim 19, further comprising:
updating said training model based on information associated with the information indicating said classification of the second set of images; and
applying said updated training model to a third set of images.
